(19) United States
(12) Patent Application Publication
(10) Pub. No.: US 2007/0160792 A1
(43) Pub. Date: Jul. 12, 2007

(54) Tamper evident closure

(76) Inventor: Jan Petrus Human, Heldervue (ZA)

Correspondence Address: DALINA LAW GROUP, P.C., 7910 IVANHOE AVE. #325, LA JOLLA, CA, 92037, US

(21) Appl. No.: 10/587,647

(22) PCT Filed: Dec. 23, 2004
(86) PCT No.: PCT/ZA04/00162

§ 371 Date: Jul. 27, 2006

(30) Foreign Application Priority Data
May 20, 2004 (ZA) 2004-3984
May 10, 2004 (ZA) 2004-1930
Jan. 27, 2004 (ZA) 2004/0618

(51) Int. Cl. B29C 47/00; B32B 1/08

(52) U.S. Cl. 428/36.9

(57) ABSTRACT

Preforms (90) from which bottles can be blown are disclosed. Each disclosed preform has a body, a flange (92) encircling the body and a band (94) protruding from the body. The flange (92), the band (94) and the part of the body above the flange (92) define a trough (106). When a cap (102) is fitted, the ring (112) is joined to the remainder of the cap's skirt along a weakened line (108), as well as the weakened line and the adjacent part of the remainder of the skirt (104), enter the trough. The band (94) can be heat shrunk onto the ring (112).

### FIELD OF THE INVENTION

THIS INVENTION relates to tamper evident caps for containers.

### BACKGROUND TO THE INVENTION

The question of tampering has become of great concern to companies that sell products in bottles and other containers with snap-fitted or screwed-on caps. It has become clear, however, that known caps are neither tamper proof nor tamper evident.

The most commonly used type of tamper evident threaded closure has a series of protrusions which project inwardly from a skirt and interlock with a bead of the container. The protrusions are on a band which forms part of the skirt and which is joined along a line of weakening to the remainder of the skirt. The band itself has a transverse line of weakening extending across it. It is intended that any attempt to remove the cap causes the band to break along its transverse line of weakening. However, it is possible with care to remove such a closure without damaging it, and then screw it back onto the bottle again without damaging it. It consequently does not reveal tampering.

The present invention seeks to provide a closure in which it is features of the container, as opposed to features of the cap, which ensure that removal of the cap inevitably results in the destruction of parts of the cap and/or of the container thereby revealing that the container has been opened.

### BRIEF DESCRIPTION OF THE INVENTION

According to a first aspect of the present invention there is provided a preform from which a container can be blown, the preform being of a heat shrinkable material and having a circumferentially extending flange encircling a neck of the preform and protruding therefrom, there being a band upstanding from the flange, the band encircling the neck and being connected to a face of the flange, the band, the flange and the part of the preform adjacent the flange defining a trough.

The neck can have a bead adjacent the flange, the bead being positioned so that on shrinking of the band onto the neck, a part of the band is on the side of the bead remote from the flange. In this form the band can be connected to the face of the flange by way of a series of circumferentially spaced bridges, there being openings between adjacent bridges.

In a preferred preform construction, said band is hollow and has a radially inner wall one circular edge of which is joined to the flange and a radially outer wall spaced from the inner wall and having one circular edge joined to the flange, there being a cylindrical gap between said walls and the upper ends of the walls being joined to one another to close that end of said gap, the other end of the gap being open and constituting a circular slot in the flange.

According to a second aspect of the present invention there is provided a container and a cap, the container being blown from a preform as defined in the three preceding paragraphs, the cap having a skirt and the free edge of the skirt being gripped between the band and the container.

According to a third aspect of the present invention there is provided a preform from which a container can be blow, the preform being of heat shrinkable material and having a circumferentially extending flange, a radially inner part of the flange being thicker than a radially outer part of the flange.

The outer part of the flange can have radially out part of said flange has radially extending gaps in it whereby the flange is discontinuous in form.

The skirt can have a protruding bead that the band shrinks onto to prevent the skirt being withdrawn from the trough without breaking it.

According to a fourth aspect of the present invention there is provided a method of manufacturing a preform which comprises moulding a preform having a flange which encircles a neck thereof and urging a cylindrical tool against the flange whilst it is in a heated, softened condition to displace material of the flange out of the plane of the flange and provide an encircling band which protrudes from the flange.

Said flange can have a radially inner part which is thicker than a radially outer part, and it is the radially outer part which is displaced by said tool to form the band.

According to a fifth aspect of the present invention there is provided, in combination a container and a cap, the container having a neck which is encircled by a flange, there being a band which protrudes from the flange, the band, the part of the flange which lies radially inwardly of the band and the part of the surface of the neck which is immediately adjacent the flange defining a trough, the free edge of a skirt of the cap fitted to said neck being in said trough.

The skirt can have a line of weakening around it which divides it into a main portion and a ring, the ring forming the free end portion of the skirt, said ring, said line of weakening and the adjacent portion of the skirt's main part being in said trough.

According to a sixth aspect of the present invention there is provided a method of moulding a preform which comprises a hollow body and a flange encircling the hollow body, the method comprising moulding a band onto the flange, the band, the flange and the part of the body adjacent the flange forming a trough, the band being moulded so that slopes towards the body from its junction with the flange, and the band being expanded outwardly after moulding to enhance its ability to shrink when heated.

In a preferred form of the method, the band is expanded by a part of the mould in which the preform is produced as the mould is opened. In another form the band is expanded by blowing air into said trough.

According to a seventh aspect of the present invention there is provided a method of capping a container which comprises attaching a cap comprising a transverse end wall and a skirt with a line of weakening around it to a container having a container body and a neck so that the edge portion of the skirt of the cap remote from the transverse end wall and said line of weakening enters a trough of the container which trough is bounded by a flange of the preform, by a band protruding from the flange and by that part of the neck adjacent the flange.

According to an eighth aspect of the present invention there is provided, in combination:
a cap comprising a transverse end wall and a skirt, there being a line of weakening which extends around the skirt and divides it into a main part and a ring at the end of the skirt remote from the transverse end wall;
a container of heat shrinkable material comprising a container body and a neck extending to the container's mouth, there being a flange encircling the neck and a band extending from the flange towards the container's mouth, the flange, the band and a part of the neck immediately adjacent the flange defining a trough;
said band, said line of weakening and the portion of the main part of the skirt which is immediately adjacent said line of weakening being in said trough, the band having been heated so that it has shrunk onto the cap to grip said ring and said portion between itself and the container neck.

According to a ninth aspect of the present invention there is provided a method of forming the neck of a container which neck has end-to-end sleeves of different diameters, the larger diameter sleeve being between the smaller diameter sleeve and the remainder of the container, the method comprising forcing the smaller diameter sleeve into the larger diameter sleeve so as to fold the larger diameter sleeve and form a trough encircling the part of the smaller diameter sleeve which is within the larger diameter sleeve.

### BRIEF DESCRIPTION OF THE DRAWINGS

For a better understanding of the present invention, and to show how the same may be carried into effect, reference will now be made, by way of example, to the accompanying drawings in which:

FIG. 1 illustrates a preform and a cap;

FIG. 2 is a pictorial view showing another preform and cap;

FIG. 3 is an axial section showing the preform of FIG. 1 with a cap screwed onto it;

FIG. 4 is a pictorial view of the cap and preform of FIGS. 2 and 3 with a portion cut away;

FIG. 5 is a section showing the preform and cap of FIGS. 2 to 4 after heat treatment;

FIG. 6 illustrates a further form of cap and preform;

FIG. 7 is a section showing the cap and preform of FIG. 6 before heat treatment;

FIGS. 8A, 8B and 8C respectively illustrate a sleeve, a preform and the sleeve fitted to the preform;

FIG. 9 illustrates a further cap and preform;

FIG. 10 is a side elevation of a preform with an extended flange protruding radially outwardly;

FIG. 11 is a top plan view of the preform of FIG. 10;

FIG. 12 is a side elevation of the preform of FIGS. 10 and 11 with the flange deformed into a cylindrical form to constitute a band;

FIG. 13 is a pictorial view of a still further preform with a quadrant cutaway to reveal its construction;

FIG. 14 illustrates a detail of the preform of FIG. 13;

FIG. 15 is a pictorial view of the preform of FIGS. 13 and 14 with a cap fitted and a quadrant cutaway;

FIG. 16 shows a closure structure which includes a flow control valve;

FIG. 17 is a side elevation of a bottle currently in commercial use;

FIG. 18 is a vertical, diametral section through the neck of the bottle of FIG. 17;

FIG. 19 is a vertical, diametral section through a modified bottle neck after blowing but before the final stage of the production procedure; and

FIG. 20 is a vertical, diametral section showing the bottle neck of FIG. 19 after being subjected to the final stage in the production procedure.

### DETAILED DESCRIPTION OF THE DRAWINGS

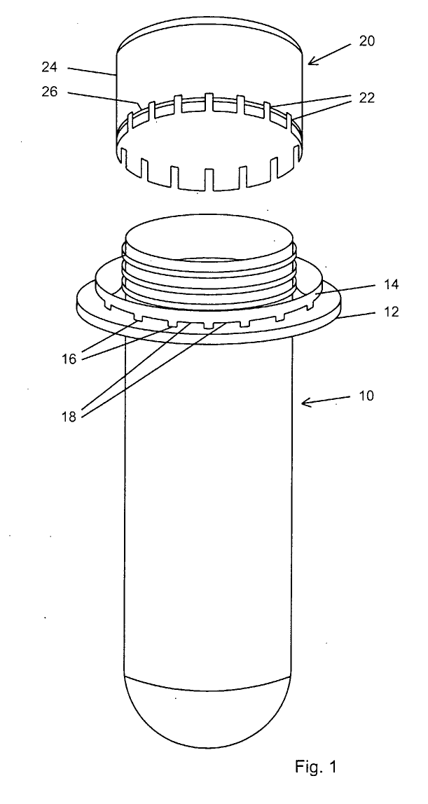

FIG. 1 illustrates a PET preform 10 from which a bottle can be blown. The preform has a flange 12 with a band 14 moulded integrally with it. The connection between the flange 12 and the band 14 is in the form of a series of bridges 16 with gaps 18 between them.

The cap designated 20 has a series of slits 22 in the free edge of its skirt 24. Externally of the skirt there is a protruding rib 26.

When the cap 20 is screwed onto the container blown from the preform 10, the edge of the skirt 24 enters the annular gap bounded by the band 14 and the neck of the container above the flange 12.

On heating of the band 14, it shrinks onto the skirt 24 above the rib 26 thereby firmly securing the skirt to the container. Unscrewing of the cap 20 causes the rib 26 to force the now brittle band 14 outwardly breaking it along a line running across the band and/or breaking the bridges 16.

The band 14 is preferably moulded with an inward lean towards the neck. The part of the mandrel which moulds the inner surface of the band 14 is tapered. This ensures that as the mould is opened, the band 14 is stretched by being expanded outwardly. Such stretching promotes shrinkage when the band 14 is shrunk onto the skirt 24 of the cap 20.

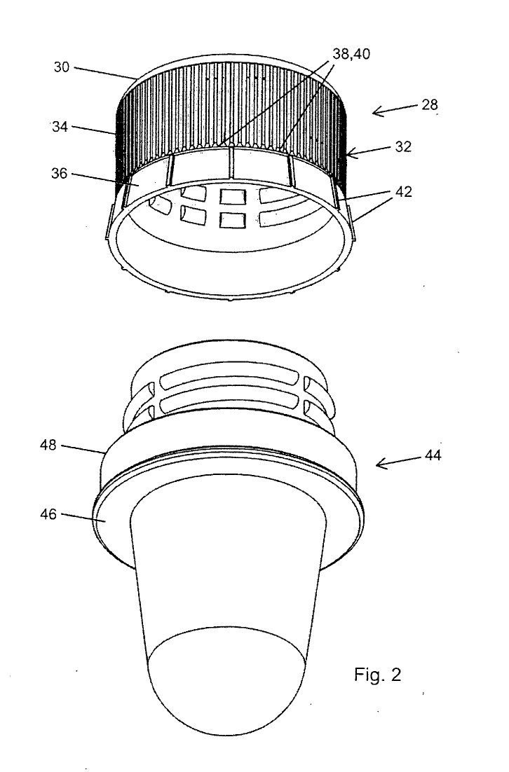

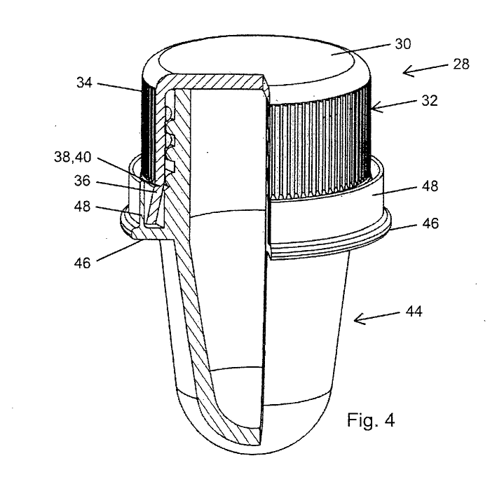

Referring now to FIGS. 2 to 5, the screw-on cap 28 shown has a transverse end wall 30 and a cylindrical skirt designated 32. The skirt 32 comprises a main part 34 and a subsidiary part in the form of a ring 36. The ring 36 is joined to the skirt part 34 by way of a series of bridges 38. There are openings 40 between adjacent bridges 38. The bridges and openings 38, 40 form a line of weakening extending around the skirt 32.

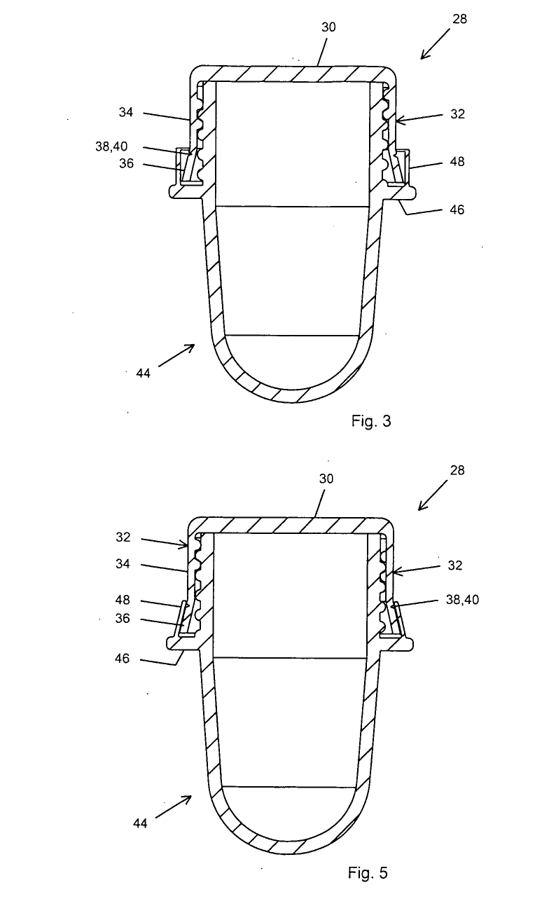

The ring 36 has a series of ribs 42 on its outer surface, the ribs extending from the line of weakening 38, 40 to the free edge of the skirt. As best seen in FIG. 3, the ring 36 flares outwardly from the line of weakening to its free edge.

FIG. 2 also illustrates a PET preform 44 from which a bottle can be blown. The preform 44 has a flange 46 and a band 48 is moulded integrally with the flange. As best seen in FIG. 3, the band 48 is cylindrical in form and, in section, is thinner than the flange 46.

In FIGS. 3, 4 and 5 of the drawings, the cap 28 is shown screwed onto the preform 44. This is purely to illustrate the relationship between the cap and the preform and it will be understood that in practice the cap is only screwed on after the preform has been blown into the form of a bottle and the bottle has been filled.

When the cap is screwed onto the bottle blown from the preform, the skirt 32 enters the annular gap bounded by the band 48 and the part of the neck of the bottle above the flange 46 to a level just above the line of weakening 38, 40 (see particularly FIG. 3).

On heating of the band 48, it shrinks onto the skirt (see FIG. 5) both above and below the bridges 38 and openings 40 thereby firmly securing the skirt to the blown bottle. The ring 36 is completely inaccessible as it is entirely covered by the band 48. Unscrewing of the cap 28 causes the cap to break along the line of weakening constituted by the bridges 38 and openings 40.

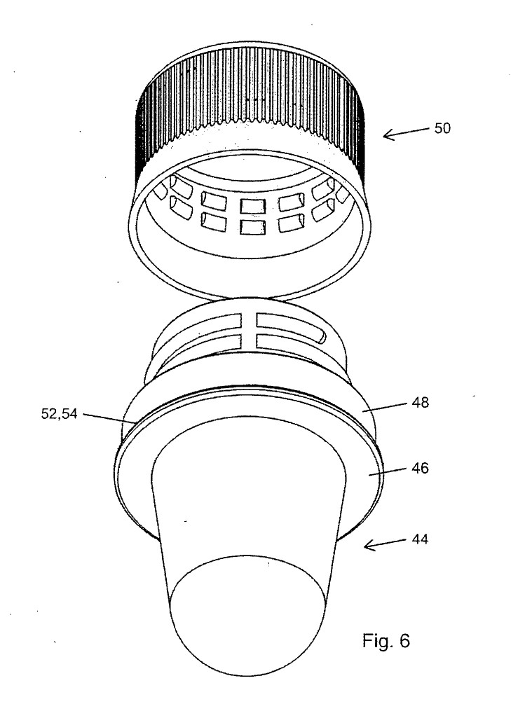

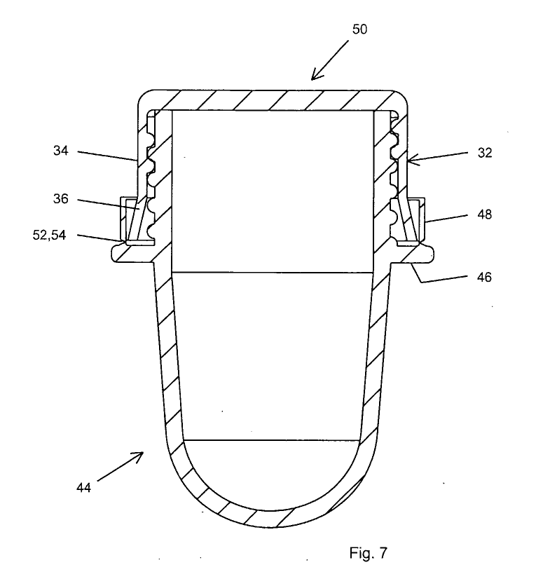

In FIGS. 6 and 7 there is shown a screw-on cap 50 which does not have ribs 42 or the line of weakening constituted by the bridges 38 and openings 40. The preform of these Figures differs from that described above in that the band 48 is not connected to the flange 46 along a continuous line but by a series of bridges 52. The bridges 52 have gaps 54 between them. The connection between the band 48 and the flange 46 is thus weakened with respect to the connection shown in FIGS. 2 to 5.

The skirt 32 enters the gap between the neck of the preform and the band 48 as the cap is screwed on. When the band 48 is heated, it shrinks onto the ring 36 and grips it tightly as described above.

Upon turning of the cap to unscrew it, the band 48 of the preform breaks off along the line of weakening where it is joined to the flange 46. The band 48 is thus removed from the blown bottle with the cap 50.

It will be understood that in the embodiment of FIGS. 6 and 7 the cap 50 does not have any weakened zones along which it can break. Thus it is the preform which fails when sufficient force is applied to the cap to rotate it and cause initial axial movement.

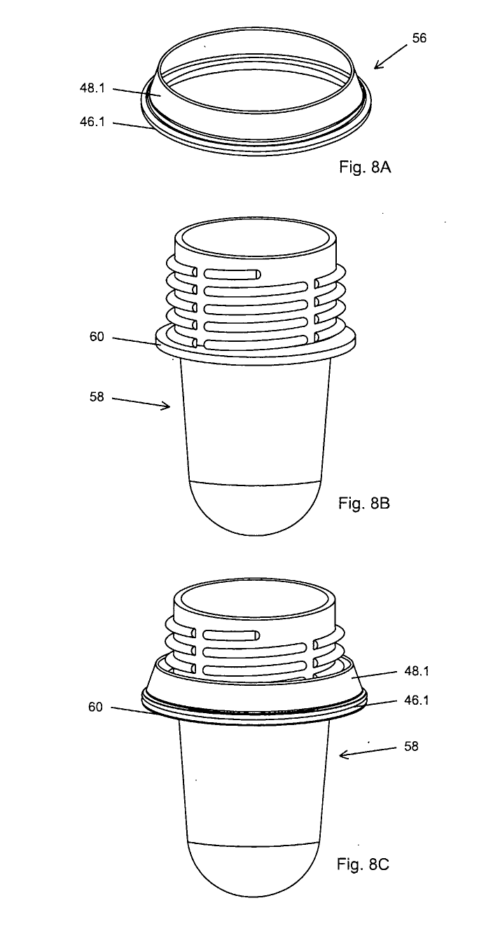

In FIGS. 8A, 8B and 8C the same reference numerals as are used above have, where applicable, been employed.

A sleeve is shown in FIG. 8A and is designated 56. The sleeve 56 comprises a flange 46.1 and a frusto conical band 48.1. The sleeve 56 is slipped over a preform, which is illustrated in FIG. 8B and is designated 58, from above or from below. The preform 58 has a flange 60 which is smaller than the flange 46 in FIGS. 2 to 7. Once the sleeve 56 is on the preform 58, it is shrunk onto the preform (FIG. 8C). The resultant combination of preform 58 and sleeve 56 is thus of the same configuration as the preform 44 of FIGS. 2 to 7.

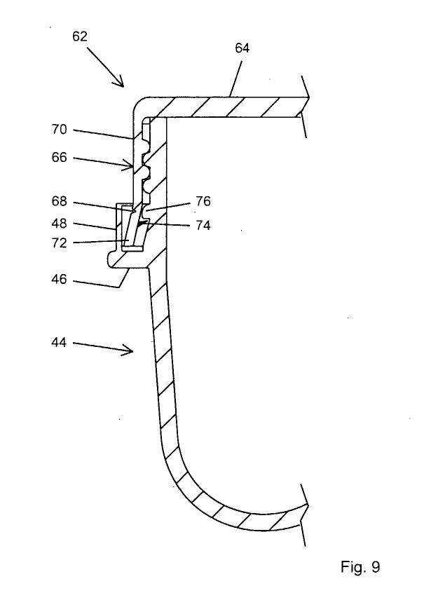

In FIG. 9 a cap is illustrated which is designated 62 and which has a transverse end wall 64 and a skirt 66. The skirt 66 has a line of weakening 68 around it which divides it into a main portion 70 and a ring 72. Inside the ring 72 there are inwardly protruding triangular flags 74 which fit under a bead 76 on the preform 44.

The band 48 extends upwardly to a level above the line 68 and, even if the band 48 is not shrunk, access to the ring 72 is prevented by ensuring that the ring 72 is a tight fit between the band 48 and the neck of the blown bottle above the flange 46. Further security is provided by shrinking the band 48.

The flange 46 and band 48 can if desired be part of a loose sleeve of the type shown at 56 in FIG. 8A.

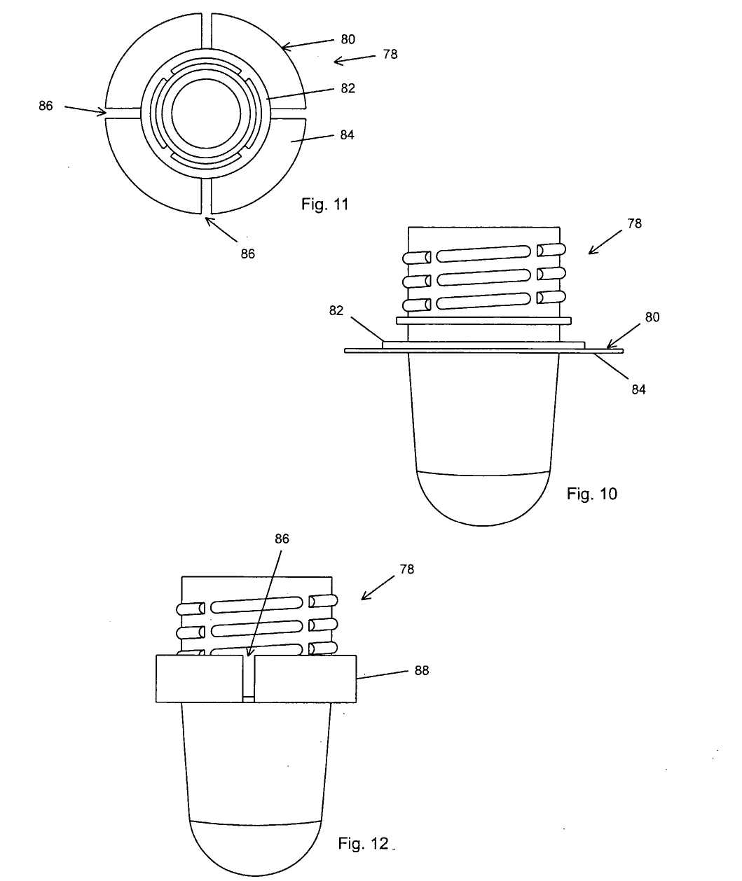

The preform 78 of FIGS. 10 to 12 includes a flange 80 which includes a thicker radially inner part 82 which is extended outwardly by a thinner radially outer part 84. The part 84 has gaps 86 (see FIG. 11) in it so that it is discontinuous rather than continuous. There is thus a step in the upper surface of the flange 80 where the parts 82, 84 join.

At a suitable point in the manufacturing procedure, the part 84 is forced upwardly (see FIG. 12) so that the flange part 84 becomes a discontinuous band designated 88. This can be done at some point in the blowing procedure, after blowing has been completed or after moulding of the preform but before blowing commences. The band 88 protrudes upwardly from the radially outer edge of the inner part 82. The gaps 86 in the band 88 do not close-up but remain and act as drainage channels through which in any liquid in the trough between the band 88 and the part of the preform above the flange 80 can escape.

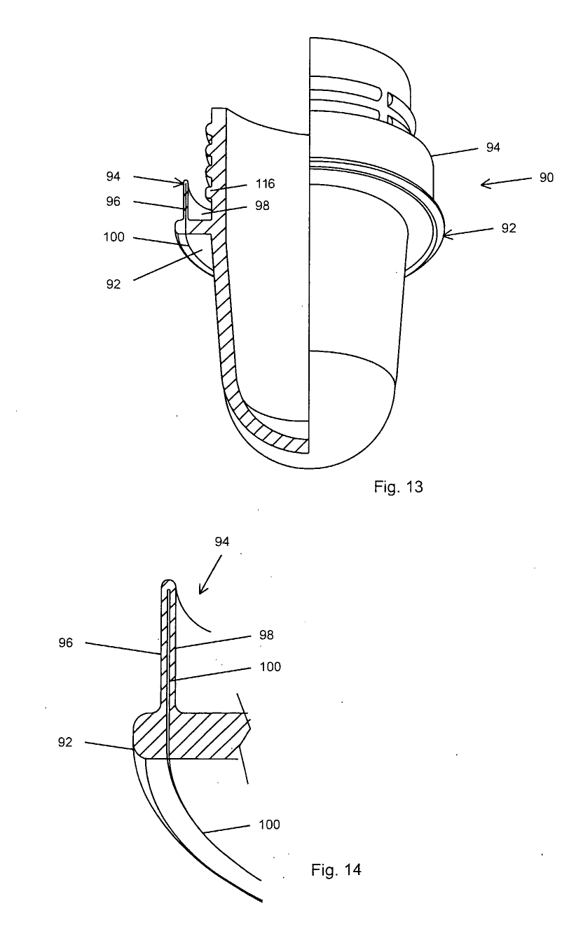

The preform 90 of FIGS. 13 and 14 is injection moulded with a conventionally shaped flange designated 92. During the blowing procedure, the flange 92 is heated to a temperature which is such that it softens. Whilst it is in this condition, one end of a tool, which is composed of a number of part cylindrical sections, is pushed upwardly against the underside of the flange 92. This has the effect of forcing material upwardly thereby creating a band 94 which encircles the neck of the preform. The band 94 is of hollow cylindrical form being composed of two spaced walls 96, 98. The gap 100 between the walls 96, 98 is open at its lower end and closed at its upper end.

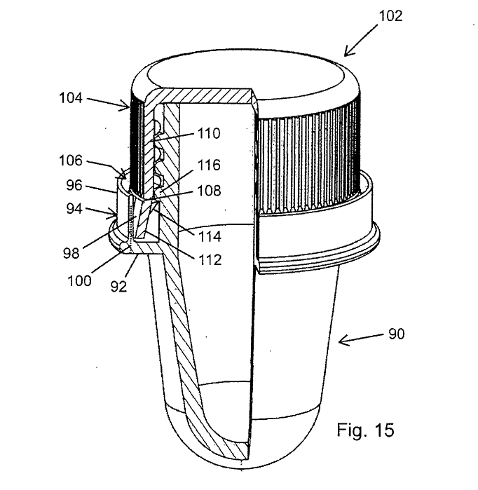

When a cap 102 (FIG. 15) is screwed onto the threading of the preform the free edge of the skirt 104 of the cap enters the annular trough 106 bounded by the band 94, the flange 92 and the part of the neck of the preform which is immediately above the flange 92. A line of weakening 108 around the skirt of the cap divides it into a main part 110 and a ring 112. Locking flags 114 on the inside of the ring 112 pass over a bead 116 of the preform. The line of weakening 108 is below the level of the upper edge of the band 94 and is hence inaccessible.

One technique used to remove a cap of the type described without damaging it is to wrap the skirt in a layer of sticky tape. The tape holds the cap together whilst sufficient torque is exerted to force the locking protrusions over the bead. Once this has been achieved the cap can be refitted and there is no evidence of tampering.

The bands 48, 48.1, 88, 94 prevent this technique being employed. Hence the cap cannot be removed without the skirt failing along its line of weakening.

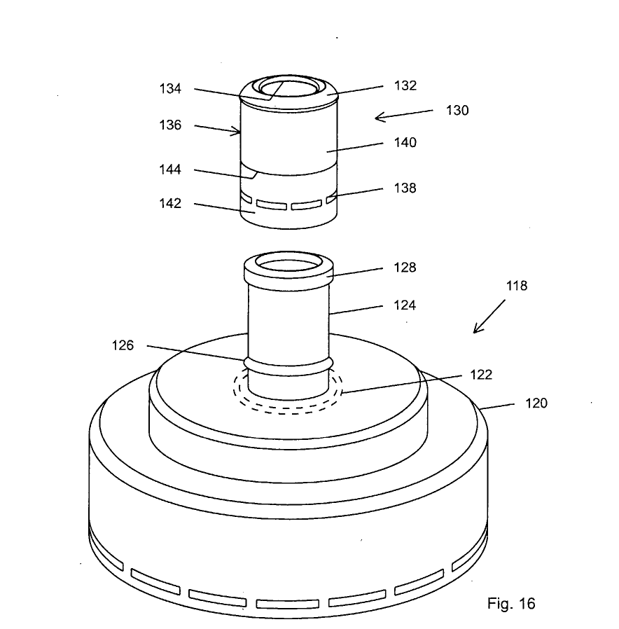

The closure structure 118 shown in FIG. 16 comprises a lid 120 which fits onto a container (not shown) which contains a liquid. The lid 120 includes a spigot 124 which is hollow and through which liquid flows from the container. The spigot has two external beads 126 and 128 which are spaced apart along the spigot 124.

A spider (not shown) within the spigot 124 carries a closure element which is co-axial with the bore in the spigot.

A cap 130 fits onto the spigot 124. The cap includes an end wall 132 which has a central opening 134. The opening 134 in the end wall 132 is encircled by a valve seat which co-operates with the valve closure element. When the cap 130 is pushed fully onto the spigot 124, the closure element abuts the valve seat.

The cap 130 also has a skirt 136 which is encircled by a line of weakening 138. This divides the skirt into a main part 140 and a ring 142.

The cap is of heat shrinkable material and is, below the line designated 144, stretched outwardly during manufacture.

After having been fitted to the spigot 124, the cap 130 is heated so that it shrinks. The ring 142, which can have locking flags on the inside of it, shrinks under the bead 126 to provide a tamper evident feature. The part of the cap between the lines 138 and 144 shrinks onto the spigot 124 between the beads 126, 128 and as a consequence cannot be slid over the bead 128. Thus the cap cannot be removed and accidentally swallowed.

A band, similar for example to the band 48, can be moulded onto the lid 120 which thus constitutes a flange equivalent to the flanges 12, 46, 80, 92 described above. The band, together with the top surface of the lid between the band and the spigot 124, and the part of the spigot 124 immediately adjacent the lid, form a trough for receiving the ring 142. The base of the band, where it merges with the lid 120, but not the remainder of the band has been shown in FIG. 16 and designated 122.

The bottle shown in FIG. 17 is of conventional form and is used for many liquid products such as oil and antifreeze. It is also used for detergents and other laundry products.

The main, hollow part 146 of the bottle is extended upwardly by a neck 148 and by a handle 150. The handle 150 curves over to join the neck 148 leaving a hand hole 152.

The neck 148 comprises an end sleeve 154 (see also FIG. 18) which has external threading 156. The sleeve 154 is joined, via an outwardly protruding bead 158, to a further sleeve 160 of greater diameter than the sleeve 154. Below the sleeve 160 there is another sleeve 162 to which the handle 150 connects and a groove 164 which imparts rigidity to the neck 148. Below the groove 164 the neck 148 connects to the walling 166 bounding the top of the hollow main part 146.

The neck 148.1 of FIG. 19 differs from that of FIG. 17 and 18 in that the sleeve 162.1 is of greater axial extent than the sleeve 162.

The sleeves 160.1, 162.1 are end to end and the sleeve 162.1 is of greater diameter than the sleeve 160.1 with the larger diameter sleeve 162.1 between the smaller diameter sleeve 160.1 and the remainder of the container.

After the bottle is blown, the sleeves 154.1, 160.1 are displaced into the sleeve 162.1 so as to “fold” the sleeve 162.1 and form an outer wall 166 and an inner wall 168 (FIG. 20) joined along a circumferentially extending hairpin bend 170.

Between the inner wall 168 and the sleeve 160.1 there is an upwardly open trough 172.

When a cap is screwed onto the neck 148.1, the ring, which is between the skirt's line of weakening and the free end of the skirt, enters the trough 172. The line of weakening also enters the trough. The locking flags of the cap are captured by the bead 158.1. Access to the band and to the line of weakening is thus prevented, and removal of the cap without breaking it along the line of weakening becomes impossible.

1. A tamper evident closure comprising a preform from which a container can be blown, said preform being of a heat shrinkable material and having a circumferentially extending flange encircling a neck of said preform and protruding therefrom, there being a band upstanding from said circumferentially extending flange, said band encircling said neck and being connected to a face of said circumferentially extending flange, said band, wherein said circumferentially extending flange and a part of said preform adjacent to said circumferentially extending flange defines a trough.

2. The apparatus as claimed in claim 1, wherein said neck has a bead adjacent said circumferentially extending flange, said bead being positioned so that on shrinking of said band onto said neck, a part of said band is on a side of said bead remote from said circumferentially extending flange.

3. The apparatus as claimed in claim 1, wherein said band is connected to said face of said circumferentially extending flange by way of a series of circumferentially spaced bridges, there being openings between adjacent bridges.

4. The apparatus as claimed in claim 1, wherein said band is hollow and has a radial inner wall one circular edge of which is joined to said circumferentially extending flange and a radial outer wall spaced from said radial inner wall and having one circular edge joined to said circumferentially extending flange, there being a cylindrical gap between said radial inner wall and said radial outer wall wherein an upper end of said radial inner wall and said radial outer wall are joined to one another to close a first end of said gap, wherein a second end of said gap is open and constitutes a circular slot in said circumferentially extending flange.

5. The apparatus as claimed in claim 1 wherein said circumferentially extending flange comprises a radial inner part of said circumferentially extending flange configured to be thicker than a radial outer part of said circumferentially extending flange.

6. The apparatus as claimed in claim 5, wherein said radial outer part of said circumferentially extending flange has radial extending gaps in said circumferentially extending flange wherein said circumferentially extending flange is discontinuous in form.

7. The apparatus as claimed in claim 1 further comprising a container and a cap, said container being blown from said perform said cap having a skirt and a free edge of said skirt being gripped between said band and said container.

8. The apparatus as claimed in claim 7 wherein said skirt has a protruding bead that said band shrinks onto to prevent said skirt from being withdrawn from said trough without breaking said skirt.

9. A method of manufacturing a tamper evident closure using a preform which comprises:
moulding a preform having a flange which encircles a neck thereof; and,
urging a cylindrical tool against said flange whilst said flange is in a heated, softened condition to displace material of said flange out of a plane of said flange to provide an encircling band which protrudes from said flange.

10. The method as claimed in claim 9, wherein said flange has a radial inner part which is thicker than a radial outer part, wherein said radial outer part is displaced by said tool to form said band.

11. A tamper evident closure comprising:
a containers and
a cap, said container having a neck which is encircled by a flange, there being a band which protrudes from said flange, said band, said part of said flange which lies radial inwardly of said band and a part of a surface of said neck which is immediately adjacent said flange defining a trough, said free edge of a skirt of said cap fitted to said neck being in said trough.

12. The apparatus of claim 11, wherein said skirt has a line of weakening around said skirt which divides said skirt into a main portion and a ring, said ring forming a free end portion of said skirt, said ring, said line of weakening and said adjacent portion of said skirt's main part being in said trough.

13. A method of moulding a preform from which to make a tamper evident closure wherein said perform comprises a hollow body and a flange encircling said hollow body, comprising:
moulding a band onto said flange,
forming a trough via said band, said flange and a part of said hollow body adjacent said flange, wherein said band is moulded so that said band slopes towards said body from a junction with said flange, and said band expands outwardly after moulding to enhance said band's ability to shrink when heated.

14. A method as claimed in claim 13, wherein said band is expanded by a part of said mould in which said preform is produced as said mould is opened.

15. A method as claimed in claim 14, wherein said band is expanded by blowing air into said trough.

16. (canceled)

17. A tamper evident closure comprising:
a cap comprising a transverse end wall and a skirt, there being a line of weakening which extends around said skirt and divides said skirt into a main part and a ring at said end of said skirt remote from said transverse end wall; and,
a container of heat shrinkable material comprising a container body and a neck extending to said container's mouth, there being a flange encircling said neck and a band extending from said flange towards said container's mouth, said flange, said band and a part of said neck immediately adjacent said flange defining a trough; said band, said line of weakening and said portion of said main part of said skirt which is immediately adjacent said line of weakening being in said trough, said band having been heated so that it has shrunk onto said cap to grip said ring and said portion between itself and said container neck.

18. A method of forming a tamper evident closure comprising a neck of a container which neck has end-to-end sleeves of different diameters, said larger diameter sleeve being between said smaller diameter sleeve and said remainder of said container, said method comprising forcing said smaller diameter sleeve into said larger diameter sleeve so as to fold said larger diameter sleeve and form a trough encircling said part of said smaller diameter sleeve which is within said larger diameter sleeve.
